(19) United States
(12) Patent Application Publication
(10) Pub. No.: US 2003/0094078 A1
(43) Pub. Date: May 22, 2003

(54) Gritted saw blade

(76) Inventor: Jon Dennis Clanton, Milwaukie, OR (US)

Correspondence Address: KLARQUIST SPARKMAN, LLP, 121 SW SALMON STREET, SUITE 1600, PORTLAND, OR, 97204, US

(21) Appl. No.: 10/275,141

(22) PCT Filed: Feb. 8, 2002
(86) PCT No.: PCT/US02/03655

(51) Int. Cl. B27B 33/14

(52) U.S. Cl. 76/101.1; 83/835; 83/665

(57) ABSTRACT

A cutting blade (10, 110, 210, 310, 410) is at least partially coated with an abrasive material (30, 32, 150, 250, 350, 450) applied by spraying metal particles onto one or both face surfaces of a cutting blade. The blade (10, 110, 210, 310, 410) is durable, with the abrasive layer (30, 32, 150, 250, 350, 450) typically not requiring replacement at anytime during the file of the table.

### BACKGROUND AND SUMMARY

The present invention relates to saws for cutting wood and other materials.

It has been a problem with saw blades that, when cutting certain materials, a blade leaves a rough edge or burr, and in some instances splits the material being cut.

The most common way to address these problems has been to increase the number teeth on a blade and reduce the spacing between the cutting tips. This is beneficial, but can substantially add to expense and is not always completely effective. Another approach, in the case of specialized rotary blades, has been to provide a sanding disk alongside the blade so that the sanding disk smoothes the workpiece being cut. Sanding disks may be useful, but are subject to rapid wear and must be replaced frequently.

It has now been discovered that otherwise-conventional blades can be partially coated with an abrasive material applied by spraying metal particles onto one or both face surfaces of a cutting blade. The resulting blade can be used in the manner of a conventional blade, with no adjustments in operation being required. Such blades are extremely durable, with the abrasive layer typically not requiring replacement at anytime during the life of the blade.

### BRIEF DESCRIPTION OF DRAWINGS

In the drawings:

FIG. 1 is a front elevational view of a circular blade having a surface with an abrasive metallized region;

FIG. 2 is an enlarged, partial sectional view taken along line 2--2 of FIG. 1;

FIG. 3 a front elevational view of a another circular blade having a surface with an abrasive metallized region;

FIG. 4 is front elevational view of a circular blade having a surface with plural abrasive metallized regions;

FIG. 5 is a front elevational view of a another circular blade having a surface with plural abrasive metallized regions; and

FIG. 6 is a partial front elevational view of a linear blade having a surface with an abrasive metallized region.

### DETAILED DESCRIPTION

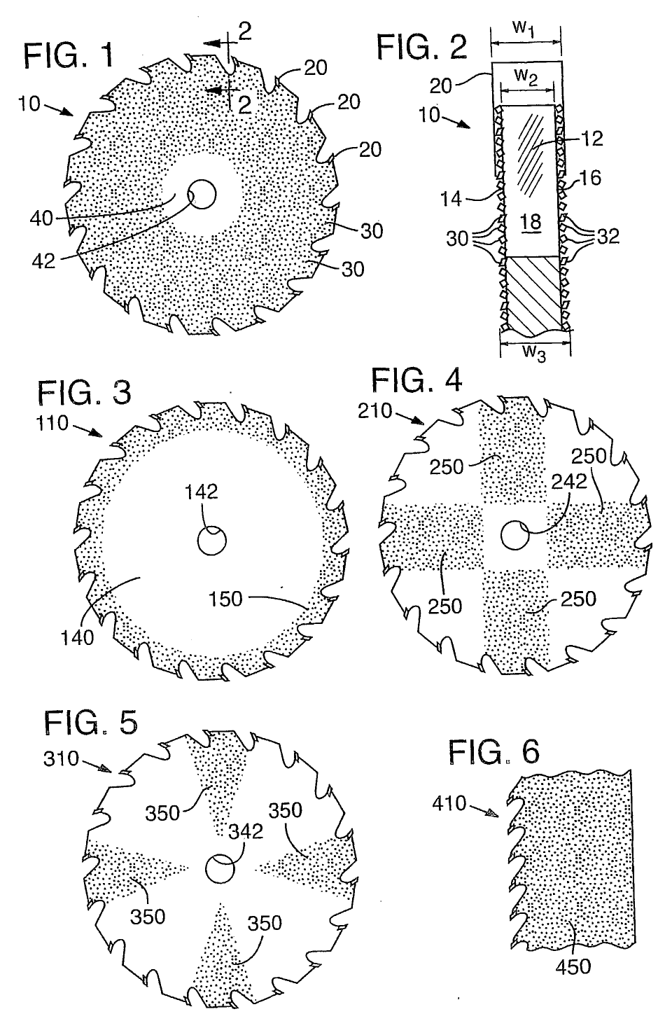

Blades of the present invention are based on the designs of standard circular or linear cutting blades, most notably blades intended for cutting wood products, particularly plywood and veneer, or plastics or soft metals such as aluminum. An example is a circular blade 10 shown in FIGS. 1 and 2. Such blades are typically made of steel and have two face surfaces 14, 16. The surfaces typically have large areas that are generally planar and that extend generally parallel to one another and that are spaced apart a distance W₂ from each other. Most styles of blades have two faces that are entirely generally planar, except for the teeth.

Blades also have cutting tips arranged along a sidewall or edge that extends between the two face surfaces. The tips typically are formed by bending tip portions of the blade material so that the tip portions extend outwardly of the planes that contain the flat surfaces portions of the blades or by attaching separately fabricated blade tips to the sidewall. In the blade of FIGS. 1 and 2, separately fabricated carbide blade tips 20 are attached to a sidewall 18 that extends between the two surfaces 14, 16 at the perimeter of a blade body 12.

The attached blade tips 20 have a width W₁ that is wider than the width W₂ of the flat portions of the surfaces 14, 16 of the blade body 12 so that a portion of each tip extends axially outwardly of the planes that coincide with the flat portions of the surfaces 14, 16. The extra width of the tips reduces the likelihood of binding during a cutting operation because the kerf created by the tips is greater in width than the width W₂ of the body 12. In a blade with tips formed by bending, each tip extends axially outwardly to only one side of the blade, typically with every other tip extending to the left or to the right of the blade body as viewed from the edge. In such bent-tooth blades, the distance W₁ is the distance between the outermost portions of the tips on each side of the blade body 12 as viewed from the edge, such that the entire blade would just fit between two planes that are slightly farther apart than the distance W₁.

Blades of the present invention advantageously have one or more regions of abrasive material applied to the surfaces 14, 16. In the blade of FIG. 1, abrasive. metal particles 30, 32 are applied to both of the surfaces 14, 16.

The metal particles are applied to an otherwise ordinary steel blade by a procedure that includes cleaning and roughening a flat portion of one or both of the surfaces 14, 16. This can be accomplished by sandblasting using aluminum oxide particles or another suitable particulate material. The sandblasting grit must be sufficiently fine, and the particle velocity sufficiently low, to avoid warping of the substrate blade.

Abrasive particles are then permanently applied to the sandblasted regions. This can be accomplished using an arc metal spraying system. Molten feedstock metal is divided into small particles of molten material by an atomizing jet. The molten metal particles are propelled against the blade where they adhere and harden to produce an abrasive surface layer. The size of the applied metal particles may be varied by adjusting the velocity of the atomizing jet, with best results with at 36-60 grit. Such abrasive metal particles can be made of carbide, such as tungsten carbide, or some suitably hard and durable metal material, such as titanium, or metal alloy. Other abrasive materials may be included.

The methods and apparatus described in U.S. Pat. No. 4,937,417 (Fox) and U.S. Patent Publication No. 20010040188 (Seitz) can be used to metallize blade surfaces as discussed herein. The resulting metallized surfaces are substantially permanent and that do not require replacement during the normal life of a cutting blade.

Best results are achieved when abrasive metal particles are applied in a substantially uniform layer, with the thickness of the particle layer being not greater than the distance to which the side surfaces of cutting tips extend outwardly from the flat surfaces of the blade body. Thus if a blade is metallized on both sides as shown in FIG. 2, with an even coating thickness on each side, the distance W₃ between the outermost portions of the coating should not be greater than the distance W₁ which is the distance between the outer most portion of the tips as viewed from the blade edge. Or in other words, the kerf cut by the tips should be at least as wide as the distance W₃ between the exposed surfaces of the metallized coatings.

Although FIG. 2 shows a blade that is coated on both sides, it would be possible to metallize a blade only on one side if so desired. For certain ripping saws where the finished edge of a workpiece will always be cut on the same side of a blade, it might not be advantageous to metallize both sides of a blade to provide an abrasive coating on both sides.

An entire side of a blade need not be metallized with the abrasive material to be effective. Cutting tips should not be spray coated with the abrasive material. And an area 40 near the arbor hole 42 of a circular saw best will remain uncoated, so that the saw may be mounted without interference from a coating.

The metallized region 50 shown in FIG. 1 is generally annular, with most of the each face of the blade being coated. FIG. 3 shows a similar arrangement, only with a larger uncoated area 140, the band 150 of metal abrasive particles being about 1-1.5 inches wide around the circumference of the blade. Other patterns of coating can be used, for example as shown in FIGS. 4 and 5 wherein plural regions 250, 350 of flat portions of blade surfaces are metallized.

As shown in FIG. 6, a linear blade 410, such as a band saw blade or a reciprocating saw blade, also can benefit from a metallized coating of abrasive metal particles. Special purpose blades, such as cylindrical hole saw blades (not shown), also beneficially can be coated with spray-applied abrasive metal particles.

Any of the illustrated blades is effective to reduce the need for sanding and for using such accessory tools as joiners, electric sanders, sanding tables, block planes and like devices that are commonly used to remove burrs and saw marks produced by a sawing operation. With blades of the present invention, the edge of a workpiece is sanded as it is cut. Overheating and binding problems are reduced by the use of such blades. And the abrasive surfaces of such blades helps clear saw dust out of the area being cut. An anti-friction coating may be placed on the metallized regions, if desired, to reduce friction.

Because the metallized surface coating extends substantially parallel to the planes which contain the flat portions of the blade surfaces 14, 16, it is not necessary to mount blades according to the present invention at abnormal angles or to make any other adjustments to normal sawing procedures.

Having illustrated and described the principles of the invention in multiple embodiments, it should be apparent to those skilled in the art that the invention can be modified in arrangement and detail without departing from such principles.

1. A cutting blade comprising:
a blade body having two face surfaces, a portion of each face surface being generally planar and extending generally in parallel to the other flat portion, and a cutting edge surface extending between the face surfaces;
a plurality of cutting tips located at the cutting edge surface; and
a generally planar layer of abrasive metal particles on a region of the generally flat portion of at least one of the face surfaces.

2. The blade of claim 1 wherein a generally planar layer of abrasive metal particles is located on a region of the generally flat portion of each of the face surfaces.

3. A method of making a cutting blade comprising:
providing a metal blade having a blade body that has two face surfaces, a portion of each face surface being generally planar and extending generally in parallel to the other flat portion, a cutting edge surface extending between the face surfaces, and a plurality of cutting tips located at the cutting edge surface; and
spray coating at least one region of at least one of the generally planar portions of the face surfaces with abrasive metal particles to provide an abrasive layer that is permanently secured to the blade body and that has a surface that extends generally in parallel to the face surfaces of the blade.

4. The blade of claim 3 wherein the layer of abrasive particles is no thicker than the distance to which at least one blade tip extends from the blade on the side of the blade having the layer.
